(19) United States
(12) Patent Application Publication
(10) Pub. No.: US 2007/0116972 A1
(43) Pub. Date: May 24, 2007

(54) Barrier coating system for refractory metal core

(75) Inventor: Joshua Persky, Boulder, CO (US)

Correspondence Address: BACHMAN & LAPOINTE, P.C. (P&W), 900 CHAPEL STREET, SUITE 1201, NEW HAVEN, CT, 06510-2802, US

(73) Assignee: UNITED TECHNOLOGIES CORPORATION

(21) Appl. No.: 11/285,564

(22) Filed: Nov. 21, 2005

(51) Int. Cl. B32B 15/04; B32B 19/00; B32B 9/00; B05D 7/00

(52) U.S. Cl. 428/457; 428/698; 428/702; 427/212

(57) ABSTRACT

A refractory metal core system for use in casting a product is provided. The refractory metal core system comprises a refractory metal core and a layer of aluminum nitride deposited on the refractory metal core, which layer of aluminum nitride acts as a bond coat. The system may further comprise a layer of alumina deposited on top of the aluminum nitride layer.

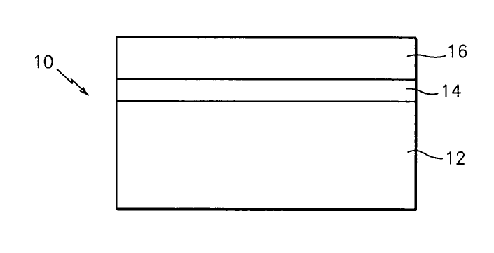

### BACKGROUND OF THE INVENTION

(1) Field of the Invention

The present invention relates to a barrier coating system for refractory metal cores used in systems for casting products such as turbine engine components.

(2) Prior Art

Thermal mismatch stresses that develop in a baseline coating system, alumina on molybdenum, may lead to microcracking, creating an oxygen permeable barrier coating. Such a coating does not provide a robust enough oxidation barrier during the standard shellfire cycle to protect the molybdenum substrate. In addition to the transverse micro crack, thicker coatings may suffer from crack deflection at the substrate interface causing gross-delaminating that leads to failure of the refractory metal core casting. Historically, a Sebastian pull test has shown that failure stresses greater than 0.75 ksi are required for repeatable castings.

Many castings using the refractory metal core technology will use six or more cores requiring coating yield to be greater than 95%. Thus, a coating system for a refractory metal core should have the following physical requirements: (1) non-reactive with molten nickel alloy; (2) phase stable at 10⁻³ torr and 1600° C.; (3) removable from the nickel alloy after casting without debiting the alloy properties; (4) provide oxidation protection during the shellfire stages of investment casting; and (5) less than 50 microns thick.

Mixed oxide deposition by chemical vapor deposition has been suggested as a longer-term solution and method to match thermal expansion coefficients and eliminate thermal mismatch stresses. Mixed oxide deposition is very difficult to control due to the catalytic effect that one species usually has on the other. Many mixed oxides also run the risk of varying in composition across the substrate as a result in different reaction rates.

### SUMMARY OF THE INVENTION

In accordance with the present invention, a bond coat for the baseline system is provided which increases adherence and lowers thermal mismatch stress.

The present invention relates to a refractory metal core system for use in casting a product. The refractory metal core system broadly comprises a refractory metal core and a layer of aluminum nitride deposited on the refractory metal core, which layer of aluminum nitride acts as a bond coat. The system may further comprise a layer of alumina deposited on top of the aluminum nitride layer.

The present invention also relates to a method for forming a refractory metal core system for use in a casting system. The method broadly comprises the steps of providing a refractory metal core and depositing a layer of aluminum nitride onto a surface of the refractory metal core. The method may further comprise the step of depositing a layer of alumina on top of the aluminum nitride layer.

Still further, the present invention relates to an article which broadly comprises a refractory metal core and a layer of aluminum nitride deposited onto a surface of the refractory metal core. The article may further comprise a layer of alumina deposited over the layer of aluminum nitride.

Other details of the barrier coating system for refractory metal cores in according with the present invention, as well as other objects and advantages, are set forth in the following detailed description and the accompanying drawing(s) wherein like reference numerals depict like elements.

### BRIEF DESCRIPTION OF THE DRAWINGS

The FIGURE illustrates a refractory metal core having a coating system in accordance with the present invention.

### DETAILED DESCRIPTION OF THE PREFERRED EMBODIMENT(S)

Referring now to the FIGURE, there is shown there a refractory metal core system in accordance with the present invention. The refractory metal core system may be used in casting processes for forming products such as cooling passages in an airfoil portion of a turbine engine component such as a turbine engine blade or vane.

The refractory metal core system 10 comprises a refractory metal core substrate 12, a layer 14 of aluminum nitride deposited on a surface of the substrate 12, and a barrier coating layer 16 deposited on the aluminum nitride layer 14. The substrate 12 may be formed from any suitable refractory metal known in the art including, but not limited to, molybdenum and molybdenum alloys. As used herein, the term “molybdenum alloys” refers to alloys having more than 50% by weight of molybdenum. The substrate 12 may be a rolled foil having a thickness in the range of from 300 to 500 microns. If the substrate 12 is formed from molybdenum, the substrate has a coefficient of thermal expansion of 4.5 ppm/° C. and a use temperature of 350° C. Further, it may be removed using 2H₂O*2HNO₃*1H₂SO₄.

The aluminum nitride layer 14 has a thickness of less than 50 microns. Preferably, the aluminum nitride layer 14 has a thickness in the range of from 3.0 to 5.0 microns. The aluminum nitride layer 14 may be deposited onto the substrate 12 using any suitable chemical vapor deposition technique known in the art. Aluminum nitride has a coefficient of thermal expansion of 5.6 ppm/° C. and a use temperature of 1375° C. Further, it may be removed using KOH, NaOH or 2H₂O*2HNO₃*1H₂SO₄.

The barrier coating layer 16 may be formed from any suitable material known in the art. Preferably, the barrier coating layer 16 is formed from alumina and has a thickness in the range of from 15 to 25 microns. The barrier coating layer 16 may be deposited using any suitable chemical vapor deposition technique known in the art. A barrier coating layer formed from alumina has a coefficient of thermal expansion of 8.5 ppm/° C. and a use temperature of about 1800° C. Further, it may be removed using KOH or NaOH.

Having an intermediate layer of intermediate thermal expansion and a functionally graded material allows for a much larger temperature range for which the coating will be stable. The alumina barrier coating grown from the vapor phase has some inherent residual porosity from the competitive growth phase. This often leads to oxidation and degradation of the substrate. The aluminum nitride layer forms a stable oxide that matches the barrier oxide exactly and prevents any further oxidation.

Aluminum nitride has the advantage of having a very high thermal conductivity, making the coating process more efficient. The material is also known to have some resistance to attack by molten alloys providing extra protection for a short period of time should the alumina barrier coating fail during casting.

The aluminum nitride bond coat of the present invention increases adherence and lowers thermal mismatch stress. Still further, it provides critical benefits to the refractory metal core coating such as oxidation resistance. The multi-layer coating of the present invention allows for the control of residual thermal stress and dissolution resistance in the molten alloy. The bond coat of the present invention has the following properties: (1) oxidation barrier; (2) stable oxide former; (3) resistance to molten alloy; (4) intermediate coefficient of thermal expansion between substrate and barrier coating; and (5) leachable with a method for core removal.

It is apparent that there has been provided in accordance with the present invention a barrier coating system for refractory metal cores which fully satisfies the objects, means, and advantages set forth hereinbefore. While the present invention has been described in the context of specific embodiments, other unforeseeable alternatives, modifications, and variations may become apparent to those skilled in the art having read the foregoing description. Accordingly, it is intended to embrace those alternatives, modifications, and variations as fall within the broad scope of the appended claims.

What is claimed is:

1. A refractory metal core system for use in casting a product, said refractory metal core system comprising a refractory metal core and a layer of aluminum nitride deposited on the refractory metal core.

2. The refractory metal core system according to claim 1, wherein said layer of aluminum nitride has a thickness less than 50 microns.

3. The refractory metal core system according to claim 1, wherein said refractory metal core is formed from a material selected from the group consisting of molybdenum and a molybdenum alloy.

4. The refractory metal core system according to claim 1, wherein said refractory metal core is formed from rolled molybdenum foil.

5. The refractory metal core system according to claim 1, further comprising a layer of alumina deposited over said layer of aluminum nitride.

6. The refractory metal core system according to claim 5, wherein said aluminum nitride has a coefficient of thermal expansion greater than the coefficient of thermal expansion of the refractory metal core and less than the coefficient of thermal expansion of the alumina layer.

7. The refractory metal core system according to claim 5, wherein said aluminum nitride layer has a thickness in the range of from 3.0 to 5.0 microns and the alumina layer has a thickness in the range of from 15 to 25 microns.

8. A method for forming a refractory metal core system for use in a casting system, said method comprising the steps of providing a refractory metal core and depositing a layer of aluminum nitride onto a surface of the refractory metal core.

9. The method according to claim 8, wherein the refractory metal core providing step comprises providing a substrate formed from a metal selected from the group of molybdenum and molybdenum alloys.

10. The method according to claim 8, wherein the refractory metal core providing step comprises providing a rolled foil formed from molybdenum.

11. The method according to claim 8, wherein the depositing step comprises depositing a layer of said aluminum nitride having a thickness less than 50 microns.

12. The method according to claim 8, wherein the depositing step comprises depositing a layer of said aluminum nitride having a thickness in the range of 3.0 to 5.0 microns.

13. The method according to claim 8, further comprising depositing a layer of a barrier coating material over said aluminum nitride.

14. The method according to claim 13, wherein said barrier coating material layer depositing step comprises depositing a layer of alumina over said aluminum nitride.

15. The method according to claim 14 wherein said alumina layer depositing step comprises depositing an alumina layer having a thickness in the range of from 15 to 25 microns.

16. An article which comprises a refractory metal core and a layer of aluminum nitride deposited onto a surface of the refractory metal core.

17. The article according to claim 16, wherein said refractory metal core is formed from a metal selected from the group consisting of molybdenum and molybdenum alloys.

18. The article according to claim 16, wherein said refractory metal core is formed from rolled molybdenum foil.

19. The article according to claim 16, wherein said aluminum nitride layer has a thickness of less than 50 microns.

20. The article according to claim 19, wherein said thickness is in the range of from 3.0 to 5.0 microns.

21. The article according to claim 16, further comprising a barrier coating material layer deposited onto said aluminum nitride layer.

22. The article according to claim 21, wherein said barrier coating material layer comprises a layer of alumina.

23. The article according to claim 22, wherein said alumina layer has a thickness in the range of from 15 to 25 microns.

24. The article according to claim 16 wherein said refractory metal core has a thickness in the range of from 300 to 500 microns.

25. A system for use in casting an article comprising:
a refractory metal core having a first coefficient of thermal expansion;
a first layer of a material having a second coefficient of thermal expansion greater than said first coefficient of thermal expansion deposited on a surface of the refractory metal core; and
a second layer of a material having a third coefficient of thermal expansion greater than said second coefficient of thermal expansion deposited over said first layer.

26. The system of claim 25, wherein said refractory metal core is formed from a metal selected from the group consisting of molybdenum and a molybdenum alloy, said first layer is formed from aluminum nitride, and said second layer is formed from alumina.

27. The system of claim 26, wherein said refractory metal core has a thickness in the range of from 300 to 500 microns, the first layer has a thickness in the range of from 3.0 to 5.0 microns, and the second layer has a thickness in the range of from 15 to 25 microns.
